(19) United States
(12) Patent Application Publication
(10) Pub. No.: US 2015/0272792 A1
(43) Pub. Date: Oct. 1, 2015

(54) Medical Securing Unit and Medical Imaging Apparatus Including the Medical Securing Unit

(71) Applicants: Daniel Driemel, Oederan (DE); Wolfgang Kraus, Fuerth (DE); Martin Zigann, Erlangen (DE); Stephan Zink, Erlangen (DE)

(72) Inventors: Daniel Driemel, Oederan (DE); Wolfgang Kraus, Fuerth (DE); Martin Zigann, Erlangen (DE); Stephan Zink, Erlangen (DE)

(21) Appl. No.: 14/671,537

(22) Filed: Mar. 27, 2015

(30) Foreign Application Priority Data
Mar. 28, 2014 (DE) 102014205836.8

(51) Int. Cl. A61G 1/044

(52) U.S. Cl. CPC A61G 1/044

(57) ABSTRACT

A medical securing unit is provided. The medical securing unit is configured to secure a position of a patient and/or of a medical accessory unit. The medical securing unit includes at least one securing strap element. The medical securing unit includes a strap storage unit with at least one retractor unit.

This application claims the benefit of DE 10 2014 205 836.8, filed on Mar. 28, 2014, which is hereby incorporated by reference in its entirety.

### BACKGROUND

For a medical imaging scan using a medical imaging apparatus on a patient, the patient is positioned on a patient couch and is taken, together with the patient couch, into a patient examination area of the medical imaging apparatus. To protect the patient, the patient is secured on the patient couch using securing straps. In addition, medical accessory units that are to be used for the medical imaging scan are secured, together with the patient, by the securing straps. These medical accessory units may encompass, for example, local coil units for a medical magnetic resonance scan and/or an EKG unit, etc.

The securing straps may be used for patients with different body volumes. This may, however, have the result that securing strap areas not required to secure the patient, the securing strap areas that are not required to secure medical accessory units, and/or protruding securing strap areas may be a hindrance when the patient couch is moved.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a medical securing unit with which securing strap areas that are not required may be safely stored is provided.

One or more of the present embodiments relate to a medical securing unit configured to secure a position of a patient and/or of a medical accessory unit and the at least one securing strap element.

The medical securing unit includes a strap storage unit with at least one retractor unit. Through this configuration, a partial portion of the securing strap element that is not required to secure the patient and/or to secure medical accessory units may be stored within the strap storage unit, and consequently, protrusion of the at least one securing strap element may be prevented. In this way, safety may advantageously be increased when moving an apparatus for accommodating a patient (e.g., the couch together with the patient), since any hindrance caused by overhanging securing strap elements that secure the patient on the couch may be prevented. As a result thereof, a safe delivery of the patient together may be achieved with the couch of the apparatus for supporting the patient to a patient scanning area of a medical imaging apparatus of, for example, a magnetic resonance apparatus, a PET apparatus, a computed tomography apparatus, etc., since any hindrance caused by overhanging securing strap elements to the sliding of the couch into the apparatus may be advantageously prevented. A withdrawal of the securing strap element from the strap storage unit may be achieved. A workflow and/or working process to prepare a patient for a medical imaging scan, for example, may thus, be simplified, and the timeframe can be optimized. The strap storage unit in question may include a single retractor unit or also two or more retractor units.

A particularly safe storage of the securing strap element may be advantageously achieved if the at least one securing strap element has two opposing end regions in the longitudinal extension of the securing strap element, and one of the end regions of the at least one securing strap element is arranged within the strap storage unit. In one embodiment, the securing strap element is affixed with one end region within the strap storage unit, such that the securing strap element is prevented from falling out of the strap storage unit.

The retractor unit includes at least one first deflecting roller and at least one second deflecting roller. This provides that a particularly space-saving storage of the securing strap element may be provided. In one embodiment, the securing strap element is guided within the strap storage unit by the deflecting rollers. Alternatively or additionally, a cord element may be guided on the deflecting rollers, and by the cord element, a roller element on which the strap element may be rolled up may be activated.

In a further embodiment, the retractor unit includes at least one first bar element and at least one second bar element that is moveably arranged relative to the at least one first bar element. The at least one first deflecting roller is arranged on the at least one first bar element, and the at least one second deflecting roller is arranged on the at least one second bar element. In this way, a distance between the at least one first deflecting roller and the at least one second deflecting roller may be varied, and hence, the length of the securing strap element that protrudes from the strap storage unit may be varied.

The retractor unit includes two or more first deflecting rollers and two or more second deflecting rollers. The two or more first deflecting rollers are arranged on the at least one first bar element, and the two or more second deflecting rollers are arranged on the at least one second bar element. The plurality of deflecting rollers provide that with a slight relative movement between the at least two bar elements, a large partial portion of the securing strap element may be deposited within the retractor unit, or a large partial region of the securing strap element may be released from the retractor unit. In this way, the retractor unit may have a particularly compact design.

In an embodiment, two or more first deflecting rollers and/or the two or more second deflecting rollers each have a radius. The individual radii of the two or more first deflecting rollers are configured differently, and/or the individual radii of the two or more second deflecting rollers are configured differently. As a result thereof, a cord guide and/or a guide for the securing strap element on, for example, small deflecting rollers within a region surrounded by a cord guide and/or a guide of the securing strap element may be arranged on large deflecting rollers. For example, the two or more first deflecting rollers and the two or more second deflecting rollers may be arranged according to a pulley system (e.g., a differential pulley system), such that a simple withdrawal of the securing strap element may be achieved by an operator applying only a slight force. The two or more first deflecting rollers with the different radii in longitudinal extension of the at least one first bar element are arranged successively on the at least one first bar element, with an increasing radius, and the two or more second deflecting rollers with the different radii in longitudinal extension of the at least one second bar element are arranged successively on the at least one second bar element, with an increasing radius.

The securing unit may be configured such that the at least one first bar element and the at least one second bar element are arranged successively along a longitudinal extension of the at least one first bar element and/or along a longitudinal extension of the at least one second bar element. As a result of this, a particularly compact medical securing unit may be provided.

Advantageously, the at least one first bar element with the first deflecting rollers arranged on the at least one first bar element is arranged such that the at least one first bar element is collinear (e.g., in mirror symmetry) with the at least one second bar element that has the deflecting rollers arranged on the at least one second bar element. Two deflecting rollers that have an identical first radius, the two deflecting rollers being arranged on different bar elements, have a greater distance between them than two further deflecting rollers with an identical second radius that is smaller than the first radius. The two deflecting rollers are arranged on different bar elements. This configuration provides that a particularly flat medical securing unit may be provided. The retractor unit may be arranged according to a pulley system (e.g., a differential pulley system), such that a particularly simple withdrawal of the securing strap element may be achieved by an operator applying only a slight force.

In one embodiment, the at least one first bar element and the at least one second bar element are arranged in parallel to one another. In this way, a particularly short overall length of the medical securing unit may be achieved.

In a further embodiment, the retractor unit includes at least one spring element that is arranged between the at least one first bar element and the at least one second bar element. As a result thereof, a retraction of the at least one bar element and/or of a cord element may be achieved during a retraction of the securing strap element by the retractor unit. The retraction of the securing strap element may thus be self-activated or automatic. A stepless withdrawal or stepless retraction of the securing strap element may be provided. A withdrawal of the securing strap element from the retractor unit causes, for example, a distance between the two bar elements to be shortened in response to a spring force from the spring element. As soon as the force that is acting against the spring force ceases to be exerted, the spring force causes a distance between the two bar elements to be enlarged such that the securing strap element is retracted by the retractor unit. For example, using the spring element, the protrusion of partial portions of the securing strap element that are not required when the patient is secured and/or the protrusion of medical accessory units may be prevented. This increases safety when moving a patient apparatus for supporting a patient (e.g., of the couch together with the patient), since hindrance from overhanging securing strap elements that secure the patient on the couch may be prevented. The spring element is configured to be magnetic resonance-compatible.

In one embodiment, the retractor unit includes a housing unit. The at least one first bar element and/or the at least one second bar element are moveably mounted on the housing unit. Thus, the retractor unit may be kept particularly compact since there is no need for units for moveably mounting the at least one first and/or the at least one second bar element.

The retractor unit includes at least one locking element that locks together a position of the at least one first bar element and a position of the at least one second bar element. In this way, after a withdrawal of a partial portion of the securing strap element, for example, an immediate retraction of the partial portion may be prevented due, for example, to a spring force of the spring element. For this purpose, the at least one locking element is configured to be moveable between a locking position, in which a withdrawal or a retraction of the securing strap element is advantageously prevented, and a further position, in which a withdrawal or a retraction of the securing strap element is possible. The locking element may be formed of a fixing element and/or a clamping element and/or of further locking elements that a person skilled in the art considers to be useful.

A particularly compact medical securing unit may be provided if the securing strap element is directly arranged within the retractor unit using the deflecting rollers. As a result thereof, the medical securing unit may be kept particularly compact. This dispenses with any further components and costs involved in providing a housing for the securing strap element.

In a further embodiment, the strap storage unit includes a winding unit that is configured to roll up or unroll the securing strap element. A rotation energy of the winding unit for rolling up or unrolling the securing strap element is transmitted to the winding unit by a cord element that is guided on the deflecting rollers. Thus, the retractor unit may be configured to be particularly compact (e.g., narrow), since the cord element may, for example, be formed from a thread and/or further cord elements that a person skilled in the art considers to be useful. For example, the retractor unit may be independent of the winding unit such that in the case of wear on components (e.g., of the securing strap element), a simple exchange of components in the winding unit alone or the retractor unit alone is to be provided.

The medical securing unit includes at least one fixing element, as a result of which the medical securing unit may be arranged on further units for securing the patient and/or medical accessory units. The medical securing unit may be directly arranged on the apparatus for accommodating a patient and/or on a medical accessory unit. As a result thereof, the medical securing unit may be removeably configured on the further units.

An advantageous distinction between different medical securing units may be achieved if the medical securing unit includes a housing unit with at least one marker element. The at least one marker element displays an available longitudinal extension of the securing strap element.

One or more of the present embodiments further relate to a medical accessory unit with at least one medical securing unit. The at least one medical securing unit is configured for securing a position of a patient and/or of the medical accessory unit and includes, for this purpose, the at least one securing strap element and a strap storage unit with at least one retractor unit. Using the medical accessory unit according to one or more of the present embodiments, the medical accessory unit may be positioned in a particularly safe manner on a patient and/or on an apparatus for supporting a patient (e.g., for a medical imaging scan). The medical accessory unit encompasses a magnetic resonance coil unit, an EKG unit, an infusion unit and/or further medical accessory units that a person skilled in the art considers to be useful, and which are to be used for a medical imaging scan, for example. The advantages and features of the medical accessory unit according to one or more of the present embodiments essentially correspond to the advantages and features of the medical securing unit according to one or more of the present embodiments, which are set out in detail in the aforementioned. Features, advantages, or alternate embodiments mentioned here may also be transferred to the other subjects for which protection is sought, and vice versa.

The medical accessory unit may also include a fixing element configured to correspond with a fixing element of the at least one medical securing unit. Thus, the medical securing unit may be arranged in a particularly fast manner on the medical accessory unit to secure the medical accessory unit based on, for example, a snap fitting between the two fixing elements. Alternatively, the medical accessory unit may also be configured such that the at least one medical securing unit is already encompassed by a housing unit of the medical accessory unit. A particularly space-saving arrangement of the at least one medical securing unit may thus be achieved.

One or more of the present embodiments further relate to an apparatus for accommodating a patient including at least one medical securing unit. The medical securing unit is configured to secure a position of a patient and/or of a medical accessory unit and includes, for this purpose, at least one securing strap element and a strap storage unit with at least one retractor unit. Using the apparatus according to one or more of the present embodiments for accommodating a patient, a patient positioned on the apparatus for accommodating a patient and/or a medical accessory unit positioned on the apparatus for accommodating a patient may be positioned in a particularly safe manner for a medical imaging scan, for example. The advantages of the apparatus according to one or more of the present embodiments for accommodating a patient essentially correspond to the advantages of the medical securing unit according to one or more of the present embodiments, which are set out in detail in the aforementioned. Features, advantages, or alternate embodiments mentioned here may also be transferred to the other subjects for which protection is sought, and vice versa.

The apparatus for accommodating a patient may include a couch to accommodate a patient. The couch includes at least one fixing element to affix the at least one medical securing unit to the couch. In this way, the medical securing unit may be arranged particularly quickly on the apparatus for accommodating a patient to secure the patient and/or a medical accessory unit. The fixing element of the couch may be configured to correspond to a fixing element of the medical securing unit.

In a further embodiment of the apparatus for accommodating a patient, the fixing element includes a fixing rail. As a result thereof, a particularly variable positioning of the medical securing unit along the fixing rail may be achieved. For example, as a result thereof, a position of the medical securing unit on the couch may be adapted to a position of an object to be secured (e.g., the patient and/or the medical accessory unit). The couch includes two fixing rails that may be arranged on the opposite lateral, edge areas of the couch. The medical securing unit may be moveably mounted within the fixing rail of the couch by a fixing element that corresponds with the fixing rail.

Alternatively, the couch in the apparatus for accommodating a patient may be configured such that the couch encompasses the at least one medical securing unit (e.g., that the at least one medical securing unit is directly incorporated into the couch). For example, a housing of the at least one medical securing unit and a housing of the couch are configured as one piece. In one embodiment, the medical securing unit may be moveably mounted completely inside a fixing rail, and the medical securing unit may be fixable in position by a fixing element of the medical securing unit.

One or more of the present embodiments also relate to a medical imaging apparatus including an apparatus for accommodating a patient, which includes a couch to accommodate a patient, and at least one medical securing unit with at least one securing strap element for securing the patient and/or a medical accessory unit on the couch. The medical securing unit includes a strap storage unit with a retractor unit. The advantages of the medical imaging apparatus according to one or more of the present embodiments essentially correspond to the advantages of the medical securing unit according to one or more of the present embodiments, which are set out in detail in the aforementioned. Features, advantages, or alternate embodiments mentioned here may also be transferred to the other subjects for which protection is sought, and vice versa.

The at least one medical securing unit according to one or more of the present embodiments may be configured to be separate from the apparatus for accommodating a patient and/or separate from the medical accessory unit. In addition, the at least one medical securing unit according to one or more of the present embodiments may be included in the apparatus for accommodating a patient and/or the medical accessory unit.

### BRIEF DESCRIPTION OF THE DRAWINGS

FIG. 1 shows a schematic diagram of a retract mode of one embodiment of a medical securing unit;

FIG. 2 shows a schematic diagram of a withdrawal mode of the medical securing unit of FIG. 1

FIG. 3 shows a schematic diagram of a withdrawal mode of an alternate embodiment of the medical securing unit;

FIG. 4 shows a schematic diagram of a retract mode of the medical securing unit shown in FIG. 3;

FIG. 5 shows a schematic diagram of an alternate embodiment of the medical securing unit with two retractor units;

FIG. 6 shows a schematic diagram of an alternate embodiment of the medical securing unit with a winding unit;

FIG. 7 shows a top view of one embodiment of an apparatus for accommodating a patient together with the medical securing unit;

FIG. 8 shows a cross-sectional view of the apparatus for accommodating a patient together with the medical securing unit;

FIG. 9 shows a cross-sectional view of an alternate embodiment of the apparatus for accommodating a patient, together with the medical securing unit;

FIG. 10 shows a top view of one embodiment of a medical accessory unit together with the medical securing unit;

FIG. 11 shows a cross-sectional view of one embodiment of a medical accessory unit together with the medical securing unit;

FIG. 12 shows a cross-section view of an alternate embodiment of the medical accessory unit together with the medical securing unit; and

FIG. 13 shows a schematic diagram of one embodiment of a medical imaging apparatus together with the medical securing unit.

### DETAILED DESCRIPTION

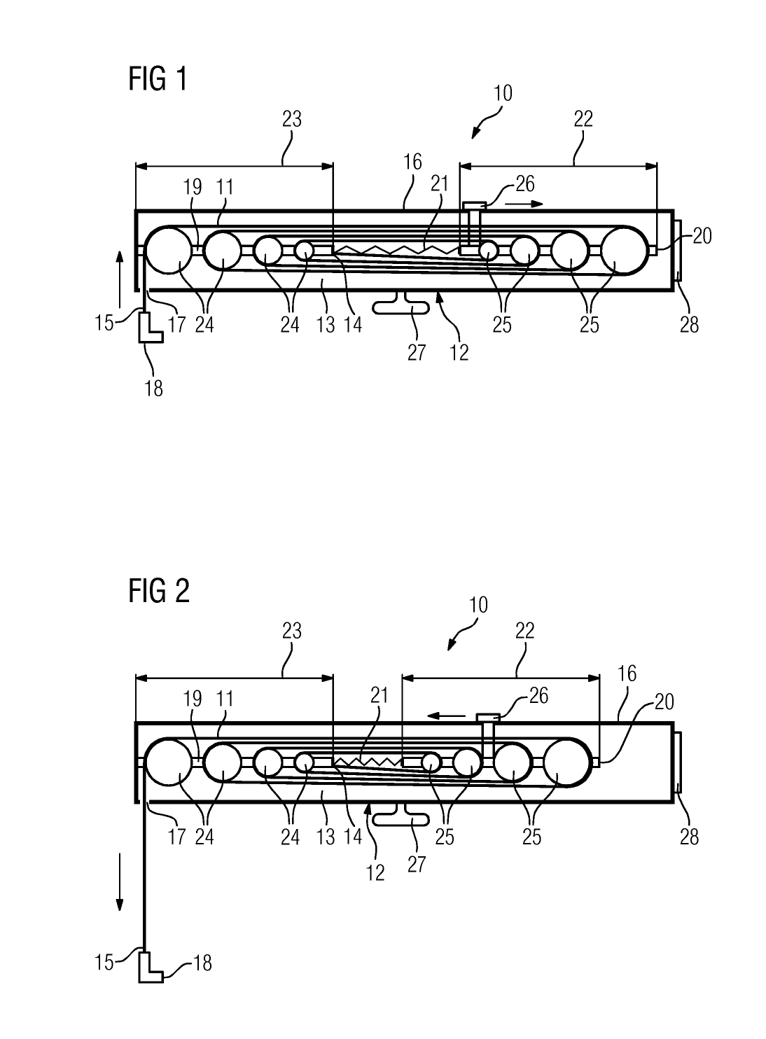

FIGS. 1 and 2 show one embodiment of a medical securing unit 10. The medical securing unit 10 includes a securing strap element 11 to secure a patient 801 and/or a medical accessory unit 600, 700 on an apparatus for accommodating a patient 400, 500 for a medical imaging scan, such as for example, a magnetic resonance scan, a computer tomography scan, a positron emission tomography (PET) scan, etc. For safe storage of partial portions of the securing strap element 11 for securing the patient 801 that are not required and/or of the medical accessory unit 600, 700, the medical securing unit 10 includes a strap storage unit 12 with a retractor unit 13.

In the longitudinal extension of the securing strap element 11, the securing strap element 11 includes two opposite end portions 14, 15. A first end portion 14 is arranged inside the strap storage unit 12. For this purpose, the end portion 14 of the securing strap element 11 that is arranged inside the strap storage unit 12 is fixed inside the strap storage unit 12. The strap storage unit 12 further includes a housing unit 16 that has a bar-shaped recess 17. A second end portion 15 of the two opposite end portions 14, 15 of the securing strap element 11 protrudes out of the bar-shaped recess 17 in the housing unit 16. In addition, a fixing element 18 is arranged on the second end portion 15 of the securing strap element 11. In the present embodiment, the fixing element 18 includes a hook (FIGS. 1 and 2). The fixing element 18 may also be at least partially formed by, for example, a velcro-type fastener, a fixing element and/or a locking element and/or may be formed by further fixing elements 18 that a person skilled in the art considers to be useful.

FIG. 1 shows the medical securing unit 10 in retract mode, in which a maximum portion of the securing strap element 11 is stored inside the strap storage unit 12. FIG. 2 shows the medical securing unit 10 in a withdrawal mode, in which a smaller portion, which is smaller than the maximum portion, of the securing strap element 11, is stored inside the strap storage unit 12.

The retractor unit 13 includes a first bar element 19 and a second bar element 20 (e.g., two bar elements). The two bar elements 19, 20 are arranged collinearly with each other or arranged successively along a longitudinal extension 23 of the first bar element 19 or along a longitudinal extension 22 of the second bar element 20. The two bar elements 19, 20 are arranged apart from each other. A spring element 21 is arranged between the first bar element 19 and the second bar element 20. In the present embodiment, the spring element 21 is configured to be magnetic resonance-compatible. Insofar as the use of the medical securing unit 10 is intended to occur outside a magnetic resonance apparatus, a design of the spring element 21 that deviates therefrom is also possible.

In the present embodiment, the first bar element 19 is fixably mounted on the housing unit 16 of the strap storage unit 12, and the second bar element 20 is moveably mounted on the housing unit 16 of the strap storage unit 12. The second bar element 20 is moveably mounted on the housing unit 16 along the longitudinal extension 22 of the second bar element 20. For this purpose, the housing unit 16 may also include additional sliding elements and/or bearing elements that are not described in further detail. Alternatively or additionally, the two bar elements 19, 20 may be moveably mounted on the housing unit 16.

The retractor unit 13 further includes a number of first deflecting rollers 24 and a number of second deflecting rollers 25. The number of first deflecting rollers 24 are arranged on the first bar element 19, and the number of second deflecting rollers 25 are arranged on the second bar element 20. In the present embodiment, the retractor unit 13 includes four first deflecting rollers 24 and four second deflecting rollers 25. The individual deflecting rollers 24, 25 are, in addition, arranged in parallel with a longitudinal extension of the bar-shaped recess 17 of the housing unit 16 inside the retractor unit 13.

The first deflecting rollers 24 vary with respect to a radius of the individual first deflecting rollers 24. Likewise, the second deflecting rollers 25 vary with respect to the radius of individual second deflecting rollers 25. The four first deflecting rollers 24 are arranged successively on the first bar element 19 along the longitudinal extension 23 of the first bar element 19. Along a direction from an end of the first bar element 19 that faces towards the second bar element 20 to an end of the first bar element 19 that faces away from the second bar element 20, the individual first deflecting rollers 24 are arranged successively on the first bar element 19 with the radius ascending in size. The first deflecting roller 25, which has the smallest radius, has a distance between the first deflecting roller 25 and the second bar element 20. The distance for the first deflecting roller 24 with the smallest radius is smaller than a distance between a further first deflecting roller 24, arranged on the first bar element 19, and the second bar element 20.

Similarly, the four second deflecting rollers 25 are also arranged successively on the second bar element 20 along the longitudinal extension 22 of the second bar element 20. Along a direction from an end of the second bar element 20 that faces towards the first bar element 19 to an end of the second bar element 20 that faces away from the first bar element 19, the individual second deflecting rollers 25 are arranged successively on the second bar element 20 with a radius that ascends in size. The second deflecting roller 25, which has the smallest radius, has a distance between the second deflecting roller 25 and the first bar element 19. The distance for the second deflecting roller 25, which has the smallest radius, is smaller than a distance between a further second deflecting roller 25, arranged on the second bar element 20, and the first bar element 19. The first deflecting rollers 24 and the second deflecting rollers 25 are arranged such that the first deflecting rollers 24 and the second deflecting rollers 25 are collinear with each other.

The securing strap element 11 is directly mounted and/or guided inside the retractor unit 13 on the individual deflecting rollers 24, 25. The securing strap element 11 is affixed onto the first bar element 19 by the end portion 14, which is arranged inside the retractor unit 13, and is then guided across the second deflecting roller 25 that has the smallest radius to the first deflecting roller 24 that has the smallest radius. From there, the securing strap element 11 is guided to the second deflecting roller 25 that has the second smallest radius. From there the securing strap element 11 is guided to the first deflecting roller 24 that has the second smallest radius and so on, until the securing strap element 11 reaches the first deflecting roller 24 that has the largest radius. The guiding of the securing strap element 11 by the deflecting rollers 24, 25 that have the small radius is provided inside an area surrounded by the guide system for the securing strap element 11 using the deflecting rollers 24, 25 that have the large radius. The securing strap element 11 is consequently arranged in a spiral inside the retractor unit 13 using the individual deflecting rollers 24, 25. From the first deflecting element 24 that has the largest radius, the securing strap element 11 is guided into the recess in the housing unit 16 of the strap storage unit 12.

The strap storage unit 12 includes a locking element 26 that locks a position of the second bar element 20 with respect to the housing unit 16 and hence also with respect to the first bar element 19. The locking element 26 may include a fixing element and/or a clamping element and/or further elements that a person skilled in the art considers to be useful. The locking element 26 is moveably mounted between a locking position and a further position of the housing unit 16.

In the present embodiment, the medical securing unit 11 includes a fixing element 27. The medical securing unit 11 may be fixed by the fixing element 27 onto a medical accessory unit 600, 700 and/or on an apparatus for accommodating a patient 400, 500 (FIGS. 1 and 2). In the present case, the fixing element 27 is T-shaped. A design of the fixing element 27 that deviates therefrom may also be provided.

The medical securing unit 11 includes a marker element 28 that is arranged on the outside of the housing unit 16. Using the marker element 28, an available strap length of the securing strap element 11 is displayed. For example, to mark the available strap length of the securing strap element 11, the marker element 28 may include an “S”, “M”, “L” or “XL”, etc.

FIG. 1 shows the strap storage unit 12 with the largest possible partial portion of the securing strap element 11 inside the retractor unit 13. The first bar element 19 and the second bar element 20 have, for example, a maximum distance between them. The first deflecting rollers 24 have, for example, a maximum distance from the second deflecting rollers 25, such that a maximum securing strap length of the securing strap element 11 may be deposited between the deflecting rollers 24, 25. Using a spring force of the spring element 21, a maximum distance is set between the first bar element 19 and the second bar element 20. Using the locking element 26, this position of the second bar element 20 may be locked with respect to the first bar element 19.

FIG. 2 shows the strap storage unit 11 in a withdrawal mode. If a tensile force is exerted on the securing strap element 11, in the event, for example, of the securing strap element 11 being partially pulled out of the strap storage unit 12, this reduces a distance between the first bar element 19 and the second bar element 20. The operator is to apply a level of tensile force that is greater than a spring force exerted by the spring element 21 between the first bar element 19 and the second bar element 20. As a result of the tensile force, a distance between the first and the second deflecting rollers 24, 25 becomes smaller, such that a short securing strap length of the securing strap element 11 may be deposited between the deflecting rollers 24, 25. Using the locking element 26, this position of the second bar element 20 may be locked with respect to the first bar element 19.

As soon as the locking element 26 is released from a locking position, or in the event of failure to lock, the tensile force acting on the securing strap element 11 ceases to be exerted, a distance between the first bar element 19 and the second bar element 20 is increased as a result of the spring force, and hence a distance between the first deflecting rollers 24 and the second deflecting rollers 25 is likewise increased. In this way, an automatic and/or self-actuated retraction of the securing strap element 11 is provided as a result of the spring force inside the retractor unit 13. The retraction and the withdrawal of the securing strap element 11 are provided in a stepless manner as a result of the spring force exerted by the spring element 21.

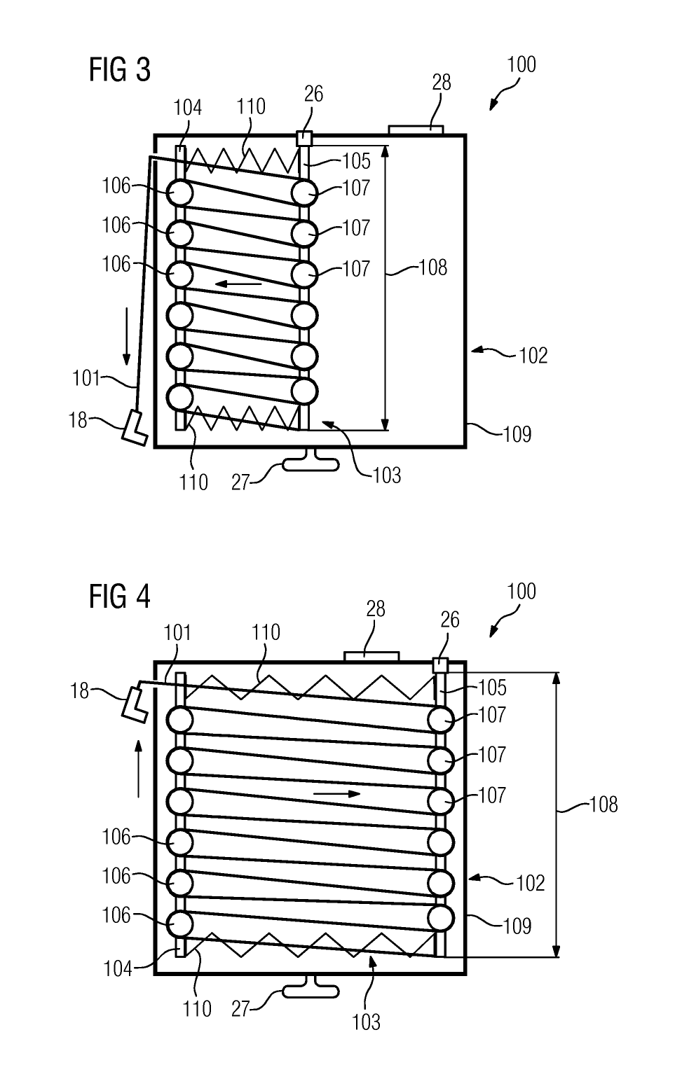

FIGS. 3 and 4 show an alternate embodiment of the medical securing unit 100. Components, features, and functions that essentially remain the same are denoted by the same reference signs. The description that follows is essentially restricted to the differences from the embodiment in FIGS. 1 and 2, reference being made to the description of the embodiment in FIGS. 1 and 2 with respect to components, features and functions that essentially remain the same.

The medical securing unit 100 includes a securing strap element 101 and a strap storage unit 102 with a retractor unit 103. The retractor unit 103 includes a first bar element 104 and a second bar element 105. The two bar elements are arranged in parallel with each other. The retractor unit 103 includes a plurality of first deflecting rollers 106 and a plurality of second deflecting rollers 107. The first deflecting rollers 106 are arranged collinearly with the first bar element 104, and the second deflecting rollers 107 are arranged collinearly with the second bar element 105. The individual deflecting rollers 106, 107 each have a radius. The radii of the individual deflecting rollers 106, 107 are equal in size.

The securing strap element 101 is directly guided on the individual deflecting rollers 106, 107. The guidance alternates between the first deflecting rollers 106 and the second deflecting rollers 107. The guidance of the securing strap element 101 is provided successively along an arrangement of the first deflecting rollers 106 on the first bar element 104 and of the second deflecting rollers 107 on the second bar element 105.

The second bar element 107 is moveably mounted on a housing unit 109 of the strap storage unit 101, transverse to (e.g., perpendicular to) a longitudinal extension 108 of the strap storage unit 101. In the present embodiment, the retractor unit 103 includes two spring elements 110 that are arranged between the first bar element 104 and the second bar element 105. The two spring elements 110 are identical in design. The first spring element 110 is arranged between a first end portion of the first bar element 104 and a first end portion of the second bar element 105, and the second spring element 110 is arranged between a second end portion of the first bar element 104 and a second end portion of the second bar element 105. As a result thereof, interference with the guiding of the strap securing element 101 is prevented by the spring element 110.

FIG. 4 shows the medical securing unit 100 in a retract mode, in which a maximum portion of the securing strap element 101 is stored inside the strap storage unit 102. FIG. 3 shows the medical securing unit 100 in a withdrawal mode, in which a small portion, which is smaller than the maximum portion, of the securing strap element 101 is stored inside the strap storage unit 102.

The further design of and functioning of the medical securing unit 100 corresponds to the design of the medical securing unit 10 in FIGS. 1 and 2, to which reference is made for this purpose.

FIG. 5 shows a further alternate embodiment of the medical securing unit 200. Components, features and, functions that essentially remain the same are denoted by the same reference signs. Components, features, and functions that essentially remain the same are denoted by the same reference signs. The description that follows is essentially restricted to the differences from the embodiment in FIGS. 1 and 2, with reference being made to the description of the embodiment in FIGS. 1 and 2 with respect to components, features, and functions that remain the same.

The medical securing unit 200 in FIG. 5 includes two securing strap elements 201, 202 and a strap storage unit 203. The strap storage unit 202 includes two retractor units 204, 205. Each of the retractor units 204, 205 is configured in a similar manner to the designs in FIGS. 1 and 2. A mode of function of the retractor units 204, 205, shown in FIG. 5, likewise corresponds with the mode of function of the designs shown in FIGS. 1 and 2. Alternatively, the two retractor units 204, 205 may be configured in a similar manner to the embodiments shown in FIGS. 3 and 4.

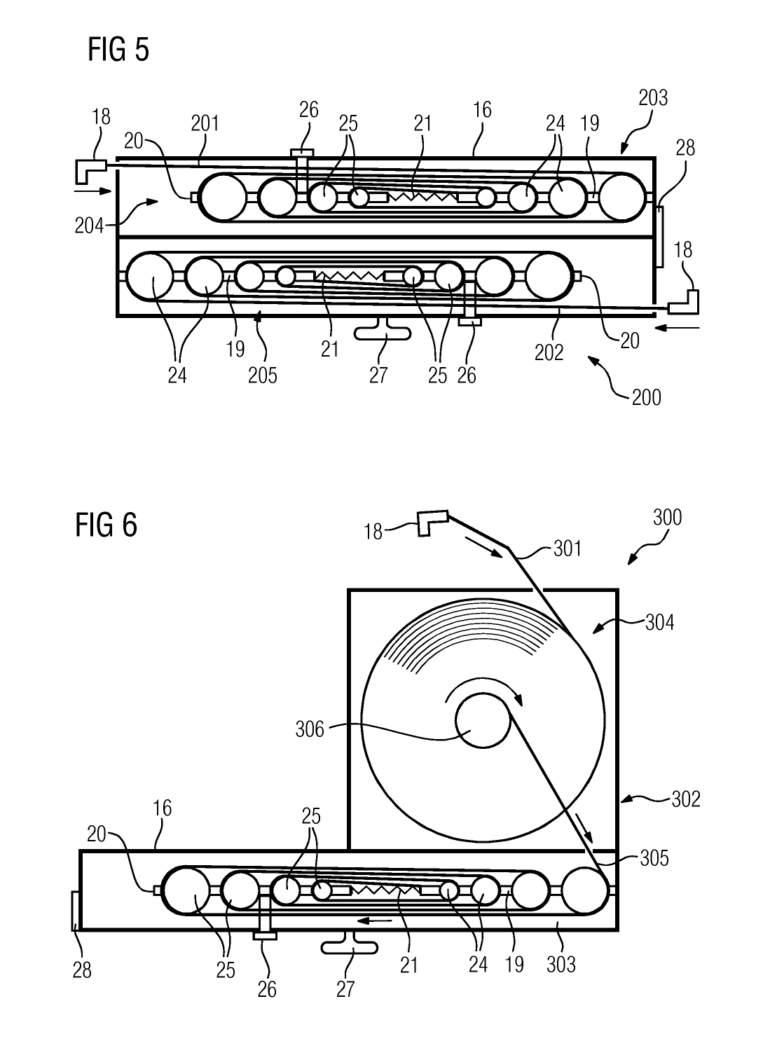

FIG. 6 shows a further alternate embodiment of the medical securing unit 300. Components, features, and functions that essentially remain the same are denoted by the same reference signs. The description that follows is essentially restricted to the differences from the embodiment in FIGS. 1 and 2, with reference being made to the description of the embodiment in FIGS. 1 and 2 with respect to components, features, and functions that essentially remain the same.

The medical securing unit 300 includes a securing strap element 301 and a strap storage unit 302 with a retractor unit 303. The strap storage unit 302 further includes a winding unit 304 for winding up and/or unrolling the securing strap element 302.

The retractor unit 303 includes a cord element 305 that is guided in a similar manner to the securing strap element 11 in the embodiment in FIGS. 1 and 2 using deflecting rollers 24, 25. The design of the retractor unit 303, with respect to an arrangement of bar elements 19, 20 and an arrangement and/or configuration of the deflecting rollers 24, 25, corresponds with the retractor unit 13 in FIGS. 1 and 2. Alternatively, the two retractor units 303 may be configured in a similar manner to the embodiments in FIGS. 3 and 4.

The cord element 305 may, for example, be configured as a thread. Further variants of the cord element 305 that differ from that of a thread may be provided at any time.

A partial portion of the retractor unit 303 that protrudes from the cord element 305 is arranged on a roller element 306 of the winding unit 304. Using the roller element 306, the strap securing element 301 is rolled up onto the roller 306 or unrolled, depending on a rotation direction of the roller element 306. The cord element 305 is arranged on the roller 306 such that a rolling up or an unrolling of the securing strap element 301 is not hindered.

When the securing strap element 301 is withdrawn, a tensile force is transmitted by the securing strap element 301 to the winding unit 306. This tensile force effects a rotation of the roller element 306, such that the cord element 305 is rolled up onto the roller element 306. This again effects a withdrawal of the cord element 305 out of the retractor unit 303, such that a distance between the two bar elements 19, 20 of the retractor unit 202 is shortened in response to a spring force of the spring element 21.

As an alternative to the example described in FIGS. 1 to 6, the retractor unit 13, 103, 203, 303 may also include two first bar elements 19, 104 and two second bar elements 20, 105 that are mounted in each case with an end portion on opposite sides of the housing unit 16, 109.

In an alternate configuration, the retractor unit 13, 103, 203, 303 may also include a different number of first and second deflecting elements 24, 25, 106, 107 than shown in FIGS. 1 to 6. The retractor unit 13, 103, 203, 303 may also be provided with only one single first deflecting roller 19, 106 and one single second deflecting roller 20, 107. The more first deflecting rollers 19, 106 and the more second deflecting rollers 20, 107 are arranged inside the retractor unit 13, 103, 203, 303, the greater is the portion of the strap securing elements 11, 101, 201, 202, 301 that may be stored in the retractor unit 13, 103, 203, 303 ready for a withdrawal.

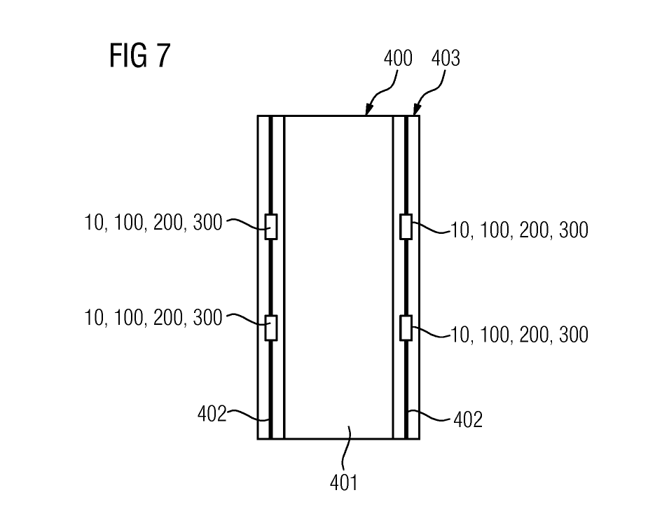

FIGS. 7 to 9 each show an embodiment of an apparatus for accommodating a patient 400, 500, with at least one medical securing unit 10, 100, 200, 300. The medical securing units 10, 100, 200, 300 shown in FIGS. 5 to 7 are configured according to one of the embodiments shown in FIGS. 1 to 6.

The apparatus for accommodating a patient 400 in FIG. 7 includes a couch 401, on which a patient is positioned for a medical imaging scan. To secure the patient and/or to secure medical accessory units 600, 700, which are required for the medical imaging scan, such as, for example, a magnetic local coil unit, an EKG unit, etc., the apparatus for accommodating a patient 400 includes a plurality of medical securing units 10, 100, 200, 300. In the present embodiment, the apparatus for accommodating a patient 400 includes four medical securing units 10, 100, 200, 300. A number of medical securing units 10, 100, 200, 300 may be adjusted to match an application and therefore be able to amount to more than four or fewer than four medical securing units 10, 100, 200, 300.

For an arrangement of the medical securing units 10, 100, 200, 300 on the apparatus for accommodating a patient 400, the apparatus for accommodating a patient 400 includes two fixing elements 402 configured to be slot-shaped. The couch 401 includes two edge areas opposite each other 403. A fixing element 402 is arranged in each case in one of the edge areas 403, such that a surface for accommodating the patient is kept unrestricted. The two fixing elements 402 are oriented parallel to the length of the couch 401.

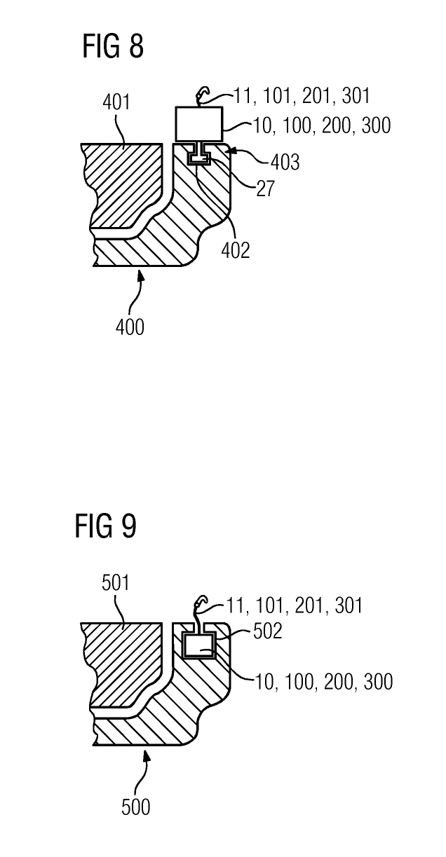

FIG. 8 shows, by way of example, a fixing of one of the medical securing units 10, 100, 200, 300 onto the couch 401. The two fixing elements 402 each include a T-shaped slot. For this purpose, the T-shaped fixing element 27 of the medical securing unit 10, 100, 200, 300 is inserted into the T-shaped slot in the couch 401. The medical securing unit 10, 100, 200, 300 may be slid inside the T-shaped slot along the longitudinal extension of the couch 401 until a desired position is achieved for the medical securing unit 10, 100, 200, 300. Using a locking element that is not shown in greater detail, the position of the medical securing unit 10, 100, 200, 300 may be locked with respect to the couch 401.

FIG. 9 shows an alternate embodiment of the apparatus for accommodating a patient 500. Components, features, and functions that essentially remain the same are basically denoted by the same reference signs. The description that follows is essentially restricted to the differences from the embodiment in FIGS. 7 and 8, with reference being made to the description of the embodiment in FIGS. 7 and 8 with respect to components, features, and functions that essentially remain the same.

FIG. 9 shows a section of one embodiment of the apparatus for accommodating a patient 500 with a couch 501 and a fixing element 502 to affix the medical securing unit 10, 100, 200, 300. The fixing element 502 is configured to be slot-shaped, in a similar manner to FIGS. 7 and 8. The slot is of such a size that the entire medical securing unit 10, 100, 200, 300 may be taken up by the slot and may be moved inside the slot along a longitudinal extension of the slot. The further design of the patient-supporting apparatus 500 corresponds to the explanations relating to FIGS. 7 and 8.

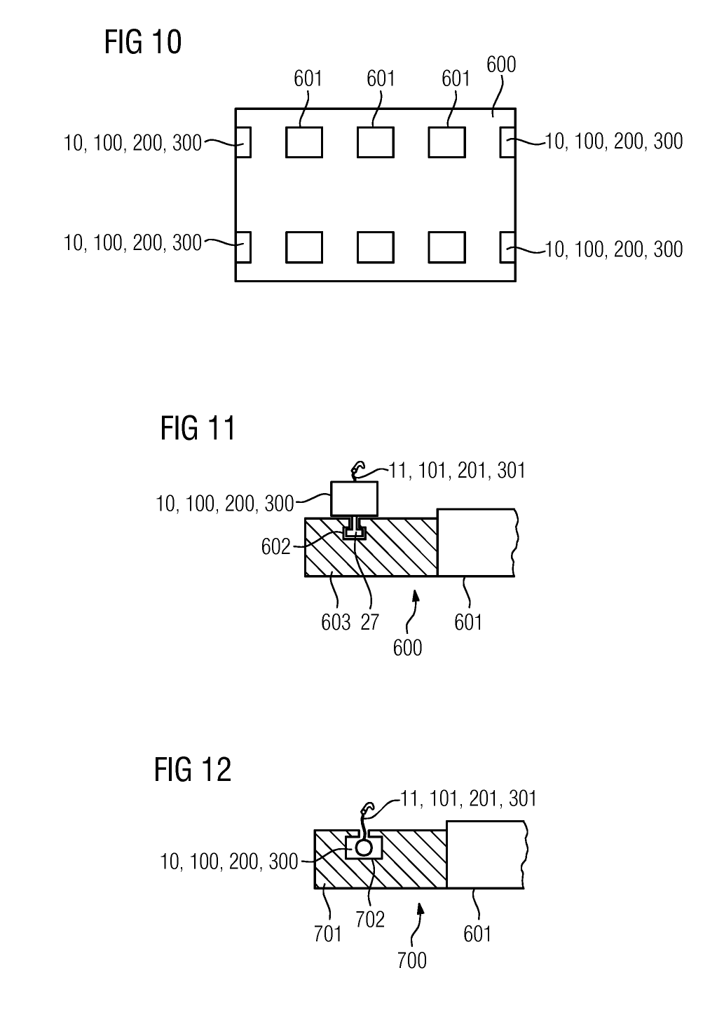

FIGS. 10 to 12 each show a medical accessory unit 600, 700 formed of a magnetic resonance coil apparatus with at least one medical securing unit 10, 100, 200, 300. The medical securing units 10, 100, 200, 300 shown in FIGS. 10 to 12 are configured according to one of the embodiments shown in FIGS. 1 to 6.

The magnetic resonance coil apparatus in FIG. 10 includes a number of coil elements 601. The magnetic resonance coil apparatus 600 includes a plurality of medical securing units 10, 100, 200, 300 to affix and/or secure the magnetic resonance coil apparatus on a patient and/or on an apparatus for accommodating a patient 400, 500. In the present embodiment, the magnetic resonance coil apparatus includes four medical securing units 10, 100, 200, 300. The number of medical securing units 10, 100, 200, 300 may be adjusted to match an application and may therefore amount to more than four or fewer than four medical securing units 10, 100, 200, 300.

FIG. 11 shows in greater detail a section of one embodiment of the magnetic resonance coil apparatus with the medical securing unit 10, 100, 200, 300. For this purpose, the magnetic resonance coil apparatus includes a fixing element 602 that is integrated into a housing unit 603 of the magnetic resonance coil apparatus. The fixing element 602 includes an L-shaped recess inside the housing unit 603. The fixing element 27 of the medical securing unit 10, 100, 200, 300 is also L-shaped. To affix the medical securing unit 10, 100, 200, 300 and the magnetic resonance coil apparatus, the fixing element 27 of the medical securing unit 10, 100, 200, 300 rests in the L-shaped recess of the magnetic resonance coil apparatus.

FIG. 12 shows an alternate embodiment of the medical accessory unit 700 configured as a magnetic resonance coil apparatus. Components, features, and functions that essentially remain the same are denoted by the same reference signs. The description that follows is essentially restricted to the differences from the embodiment in FIGS. 10 and 11, with reference being made to the description of the embodiment in FIGS. 10 and 11 with respect to components, features, and functions that essentially remain the same.

FIG. 12 shows a section of one embodiment of the magnetic resonance coil apparatus, where a housing unit 701 of the magnetic resonance coil apparatus includes a recess 702 to entirely take up the medical securing unit 10, 100, 200, 300. The housing unit 701 of the magnetic resonance coil apparatus may be configured in one piece with the housing unit 16, 109 of the medical securing unit 10, 100, 200, 300.

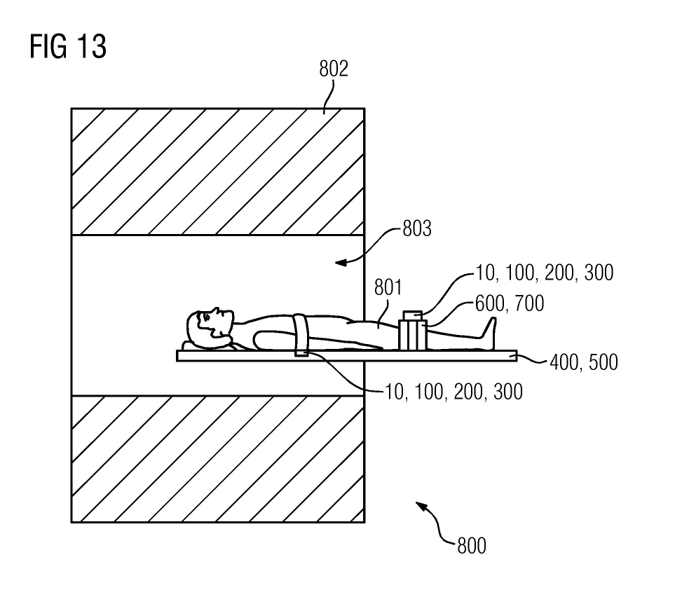

FIG. 13 shows a diagram of one embodiment of a medical imaging apparatus 800 that is formed in a magnetic resonance apparatus. Alternatively, the medical imaging apparatus 800 may also include a computer tomography apparatus, a PET apparatus, a C-arm apparatus and/or further variants of a medical imaging apparatus 800 that a person skilled in the art considers to be useful.

The magnetic resonance apparatus includes a magnet unit 802 including a main magnet to generate a strong and, for example, a constant main magnetic field. In addition, the magnetic resonance apparatus includes an area for receiving the patient 803 to receive a patient 801. In the present embodiment, the area for receiving the patient 803 is cylindrical in design and is surrounded cylindrically in a circumferential direction by the magnet unit 802. However, a design of the area for receiving the patient 803 that deviates therefrom may be provided.

The patient 801 may be pushed into the area for receiving the patient 803 by a patient-accommodating apparatus 400, 500 of the magnetic resonance apparatus. The patient-accommodating apparatus 400, 500 is configured according to one of the embodiments shown in FIGS. 7 to 9.

For a magnetic resonance scan, a medical accessory unit 600, 700, configured as a magnetic resonance coil apparatus, is arranged on the patient 801. The magnetic resonance coil apparatus shown is configured according to one of the embodiments shown in FIGS. 10 to 12.

To secure the patient 801 and/or medical accessory units 600, 700, the magnetic resonance apparatus includes medical securing units 10, 100, 200, 300. The medical securing units 10, 100, 200, 300 shown in FIG. 13 are configured according to one of the embodiments shown in FIGS. 1 to 6.

Although the invention has been illustrated and described in greater detail with the embodiments, the invention is not restricted to the examples disclosed. Other variants may be derived therefrom by a person skilled in the art without departing from the scope of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A medical securing unit configured to secure a position of a patient, a position of a medical accessory unit, or the position of the patient and the position of the medical accessory unit, the medical securing unit comprising:
at least one securing strap element; and
a strap storage unit comprising at least one retractor unit.

2. The medical securing unit of claim 1, wherein, in longitudinal extension of the at least one securing strap element, the at least one securing strap element comprises two opposite end portions, and one of the two opposite end portions of the at least one securing strap element is arranged inside the strap storage unit.

3. The medical securing unit of claim 1, wherein the at least one retractor unit comprises at least one first deflecting roller and at least one second deflecting roller.

4. The medical securing unit of claim 3, wherein the at least one retractor unit comprises at least one first bar element and at least one second bar element that is moveably arranged in relation to the at least one first bar element, the at least one first deflecting roller being arranged on the at least one first bar element, and the at least one second deflecting roller being arranged on the at least one second bar element.

5. The medical securing unit of claim 4, wherein the at least one retractor unit comprises two or more first deflecting rollers and two or more second deflecting rollers, the two or more first deflecting rollers being arranged on the at least one first bar element, and the two or more second deflecting rollers being arranged on the at least one second bar element.

6. The medical securing unit of claim 5, wherein the two or more first deflecting rollers, the two or more second deflecting rollers, or the two or more first deflecting rollers and the two or more second deflecting rollers each have a radius, and
wherein individual radii of the two or more first deflecting rollers are configured differently, individual radii of the two or more second deflecting rollers are configured differently, or the individual radii of the two or more first deflecting rollers are configured differently and the individual radii of the two or more second deflecting rollers are configured differently.

7. The medical securing unit of claim 6, wherein the two or more first deflecting rollers with the different radii in the longitudinal extension of the at least one first bar element on the at least one first bar element are arranged successively with an increasing radius, and the two or more second deflecting rollers with the different radii in longitudinal extension of the at least one second bar element are arranged successively on the at least one second bar element, with an increasing radius.

8. The medical securing unit of claim 4, wherein the at least one first bar element and the at least one second bar element are arranged successively along a longitudinal extension of the at least one first bar element, along a longitudinal extension of the at least one second bar element, or along the longitudinal extension of the at least one first bar element and along the longitudinal extension of the at least one second bar element.

9. The medical securing unit of claim 4, wherein the at least one first bar element and the at least one second bar element are arranged in parallel with one another.

10. The medical securing unit of claim 4, wherein the at least one retractor unit comprises at least one spring element that is arranged between the at least one first bar element and the at least one second bar element.

11. The medical securing unit of claim 4, wherein the at least one retractor unit comprises a housing unit, and
wherein the at least one first bar element, the at least one second bar element, or the at least one first bar element and the at least one second bar element are moveably mounted on the housing unit.

12. The medical securing unit of claim 4, wherein the at least one retractor unit comprises at least one locking element that locks together a position of the at least one first bar element and of the at least one second bar element.

13. The medical securing unit of claim 3, wherein the at least one securing strap element is directly guided inside the at least one retractor unit by the at least one first deflecting roller and the at least one second deflecting rollers.

14. The medical securing unit of claim 3, wherein the strap storage unit comprises a winding unit configured to roll up or unroll the at least one securing strap element, a rotation energy of the winding unit for rolling up or unrolling the at least one securing strap element being transmitted to the winding unit by a cord element that is guided on the at least one first deflecting roller and the at least one second deflecting roller.

15. The medical securing unit of claim 1, further comprising at least one fixing element.

16. The medical securing unit of claim 1, further comprising a housing unit with at least one marker element,
wherein the at least one marker element displays an available strap length of the at least one securing strap element.

17. A medical accessory unit comprising:
at least one medical securing unit configured to secure a position of a patient, a position of a medical accessory unit, or the position of the patient and the position of the medical accessory unit, the at least one medical securing unit comprising:
at least one securing strap element; and
a strap storage unit comprising at least one retractor unit.

18. The medical accessory unit of claim 17, further comprising a fixing element configured such that the fixing element corresponds with a fixing element of the at least one medical securing unit.

19. The medical accessory unit of claim 17, further comprising a housing unit that encompasses the at least one medical securing unit.

20. An apparatus for accommodating a patient with at least one medical securing unit, the at least one medical securing unit configured to secure a position of the patient, a position of a medical accessory unit, or the position of the patient and the position of the medical accessory unit, the at least one medical securing unit comprising:
at least one securing strap element; and
a strap storage unit comprising at least one retractor unit.

21. The apparatus of claim 20, further comprising a couch for accommodating the patient,
wherein the couch comprises at least one fixing element to affix the at least one medical securing unit.

22. The apparatus of claim 21, wherein the at least one fixing element comprises a fixing rail.

23. The apparatus of claim 20, further comprising a couch for accommodating the patient,
wherein the couch encompasses the at least one medical securing unit.

24. A medical imaging apparatus comprising:
an apparatus for accommodating a patient, the apparatus comprising a couch to accommodate the patient; and
at least one medical securing unit comprising:
at least one securing strap element for securing the patient, a medical accessory unit, or the patient and the medical accessory unit on the couch; and
a strap storage unit comprising at least one retractor unit.

25. The medical imaging apparatus of claim 24, wherein the couch comprises at least one fixing element to affix the at least one medical securing unit.
